(19) United States
(12) Patent Application Publication
(10) Pub. No.: US 2008/0034193 A1
(43) Pub. Date: Feb. 7, 2008

(54) System and Method for Providing a Mediated External Exception Extension for a Microprocessor

(76) Inventors: Michael N. Day, Round Rock, TX (US); Jonathan J. DeMent, Austin, TX (US); Charles R. Johns, Austin, TX (US); Orran Y. Krieger, Newton, MA (US); Cathy May, Millwood, NY (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/462,601

(22) Filed: Aug. 4, 2006

(51) Int. Cl. G06F 7/38

(52) U.S. Cl. 712/244

(57) ABSTRACT

A system and method for providing a mediated external exception extension for a microprocessor are provided. With the system and method, in response to an external exception, a hypervisor determines if the associated external interrupt is directed to a logical partition (LPAR) that has external interrupt handling enabled. If so, the hypervisor sets appropriate state restore registers (SRRs) and passes control to an external interrupt handler of the LPAR. If external interrupt handling is not currently enabled by the LPAR, the hypervisor sets a mediated exception request and returns control to the LPAR. Once the operating system of the logical partition re-enables external interrupt handling, a mediated external interrupt occurs, state information for the LPAR is set in the SRRs, and the external interrupt handler of the LPAR is invoked. In this way, external interrupts may be received by the hypervisor even when external interrupt handling is disabled.

### BACKGROUND

1. Technical Field

The present application relates generally to an improved data processing system and method. More specifically, the present application is directed to a system and method for providing a mediated external exception extension for a microprocessor.

2. Description of Related Art

Typically, in modern day microprocessors, such as the PowerPC® microprocessors available from International Business Machines, Inc. of Armonk, N.Y., if an input/output (I/O) device requires services from the operating system, e.g., the I/O device needs buffers assigned, has data ready, needs control information, is providing sensor input, or the like, the I/O device must interrupt the operation of the operating system (OS) or an application executing in conjunction with the operating system on the microprocessor. In order to interrupt the operation of the OS or the executing application, the I/O device generates an exception, which in turn interrupts the operating system or application on the microprocessor to handle the external exception. This exception and its associated interrupt are referred to as a direct external exception and direct external interrupt. External exceptions and interrupts may be generated by any source that is external to the microprocessor itself. Most often, these sources are other devices or processing units in the same overall system. For example, in a symmetric multiprocessor system, one processor can generate an external exception to externally interrupt the operation of another processor for messaging purposes.

The directed external interrupt, associated with a directed external exception, is an asynchronous signal from hardware indicating the need, by another processor or device, for attention by the processor or OS to which the external interrupt is directed. A hardware interrupt causes the processor to save its state of execution and begins execution of an interrupt handler. In particular, with the PowerPC® microprocessor, the state of execution is stored by the hardware in state restore registers (SRRs). The state of the machine state register (MSR) and the program counter for the executing program are stored in these SRRs, e.g., SRR0 and SRR1, so that the state of the execution may be restored after handling the exception/interrupt, i.e. when the interrupt handler issues a Interrupt Return (IRET) instruction.

Some portions of code executed by a microprocessor are not interrupt safe, i.e. state or data corruption will occur if the code is interrupted. This code is often referred to as critical section code. In order to ensure that such critical portions of code may be executed unhindered by the handling of directed external interrupts, the PowerPC® microprocessor supports the disabling of external exception handling by providing a machine state register (MSR) bit for turning on/off the capability for an external exception to trigger an external interrupt, i.e. the machine state register external exception bit (MSR[EE]). If this register has a 0 value, then external exceptions cannot generate an external interrupt and therefore external exception handling is disabled. If this register has a 1 value, then external exception handling is enabled and an external interrupt will interrupt the current program flow to execute the external interrupt handler.

If the OS determines that a critical portion of code is being executed, the OS may set the value in the MSR[EE] register to disable external exception handling. Once the critical portion of code is done executing, the OS may reset the MSR[EE] register to re-enable external exception handling. In this way, the OS guarantees that critical portions of code may execute at a priority and are not interrupted in order to perform external exception handling on behalf of an I/O device or some other unit external to the microprocessor.

While the mechanism for disabling directed external exception handling works very well in the PowerPC® microprocessor running a single OS, problems may arise when this mechanism is applied in logically partitioned environments that support multiple OS's sharing a microprocessor. These problems become even more critical when a system runs a conventional OS in one logical partition and runs, in another concurrent logical partition, a real time OS, i.e. an OS that handles activities that must be performed within given time constraints and provides guarantees that such activities are performed within specified times. Specifically, the problem of excessive exception handling latency may occur.

A significant contribution to excessive exception handling latency is the delay in execution of code or performance of activities due to the disabling of external exception handling. For example, in a logically partitioned environment in which a conventional OS operates in a first logical partition and a real time OS operates in a second logical partition, the conventional OS may disable external exception handling for an extended period of time while in a critical section of code. Similarly, the real time OS in the second logical partition may execute code for performing time-sensitive tasks. As part of the execution of the time-sensitive tasks, the logical partition control mechanism, e.g., the hypervisor, may execute instructions in the first logical partition for a specific number of cycles and then perform a context switch to the second logical partition to thereby execute instructions in the second logical partition. Such “partition-level context switches” permit the time sensitive tasks to be performed within the required time period while sharing the microprocessor with other logical partitions.

When the conventional OS in the first logical partition determines that critical code is being executed, the conventional OS temporarily disables external exception handling by setting the MSR[EE] value to 0. However, because the external exception handling is disabled in the machine state register of the single microprocessor shared by both partitions the disabling affects the external exception handling latency for both logical partitions.

This increased external exception handling may have no detrimental effect on the conventional OS function, but can cause the real time OS and application to miss critical deadlines. These external exception handling deadlines cannot be met with the standard timeslicing of the microprocessor between the logical partitions.

As a result, if an I/O device operating in conjunction with the real time OS needs to have an external exception handled in order to perform a time sensitive activity in the second logical partition, this external exception is not even presented to the OS in the second logical partition until the partition's next microprocessor timeslice, which in many cases is too late to meet the required response time for handling the external exception.

In this situation, the time sensitive activity in the second logical partition suffers from excessive exception handling latency and, in the worst cases, may not perform the time sensitive activity in the guaranteed time period. It can be appreciated that the non-performance of the time sensitive activity within the guaranteed time period may have serious consequences depending upon the activity being performed. For example, if the second logical partition were running an application for controlling a vehicle braking system, the safety of passengers in the vehicle braking system may be compromised. Other less serious consequences may be encountered in which the microprocessor itself may not operate correctly or the data being processed may become corrupted, for example.

### SUMMARY

In view of the above, it would be beneficial to have a system and method for handling the above situation in such a manner that the time sensitive external exception handling may still be completed as required in one logical partition without compromising the integrity of the other logical partition(s). The illustrative embodiments provide such a system and method by providing a mediated external exception extension which permits the presentation, of an external interrupt to the hypervisor even if external exception handling is disabled in the currently executing logical partition. The terms “interrupt” and “exception” are used interchangeably herein to refer to the occurrence of an exception in an external device and the corresponding generation of an interrupt in the operation of an operating system or application code in a logical partition.

With this mediated external exception extension, the external interrupt is provided to the logical partition control mechanism, e.g., the hypervisor, to determine if the external interrupt is to be provided to the currently running partition as a direct external interrupt or as a mediated external interrupt. In addition, if the external interrupt is for the non-currently running logical partition, the hypervisor determines if the exception priority is sufficiently high to justify a preemptive logical partition context switch to the other logical partition to present the external interrupt as a direct external interrupt or as a mediated external interrupt.

In the illustrative embodiments, when a directed external exception occurs and a logical partition is executing on the microprocessor, such as from an input/output (I/O) device or the like, the microprocessor hardware interrupts the current execution and saves the program counter and the machine state register in the hypervisor state save/restore registers (HSRRs) and starts code execution in the hypervisor's direct external interrupt handler. The state is stored in hypervisor HSRRs rather than the standard state save/restore registers (SRRs) used by the operating system of the logical partition because the logical partition may have disabled external exceptions and is assuming that the SRRs will not be modified.

The hypervisor's external interrupt handler determines if a partition level context switch is to be made. In these illustrative embodiments, it is assumed that the microprocessor is set to a state in which all external interrupts are sent to the hypervisor rather than to an operating system (OS) of a logical partition so that external exceptions may be mediated.

In response to receiving the external interrupt, for example, the hypervisor may determine a priority of the external interrupt and whether or not the external interrupt is to be handled by the currently active logical partition or another logical partition. If the external interrupt is to be handled by the currently active logical partition, then a logical partition context switch is not necessary. However, if the external interrupt is to be handled in another logical partition, it may be necessary to perform a logical partition context switch if the priority of the external interrupt is of a sufficiently high priority. For example, external interrupts that are to be handled in logical partitions running a real time operating system (OS) may be considered to be of a high priority requiring a logical partition context switch from a currently active logical partition which may be running, for example, a conventional OS without the stringent realtime response requirements.

As a result, the hypervisor stores the current state information for the current logical partition in a context storage space associated with the logical partition and the hypervisor redirects execution to the other logical partition in which the directed exception is to be handled by restoring the logical partitions saved context to the microprocessor state. This state information will include, for example, the state of the external exception enable/disable bit in the machine state register, the state of a mediated exception request (MER) bit set in a logical partition control register (LPCR), discussed hereafter, and the like.

When redirecting execution to the other logical partition, the state information stored in the context storage space for this other logical partition is restored including the previous state of the external exception enable/disable bit in the machine state register and the MER bit in the LPCR. Thus, the other logical partition may or may not have had external exceptions enabled during a previous logical partition execution and this state is restored upon a context switch back to this other logical partition.

Within the logical partition in which the external exception is to be handled, i.e. either the currently active logical partition or another logical partition, if the external exception is a directed external exception (not a mediated external exception) and that logical partition has external exceptions enabled, the hypervisor sets the appropriate registers to emulate the state save of the external interrupt corresponding to the external exception and redirects execution to the operating system's external interrupt handler in the logical partition. For example, the state save/restore registers (SRRs) are copied from the HSRRs to store the program counter and machine state register states captured at the time of the directed external exception or last context save so that this state may be restored after a return from the OS's external interrupt handler. The external interrupt handler is then run in order to process the external interrupt and returns control to the point where the logical partition would have resumed had there not been an external interrupt by issuing an Interrupt Return (IRET) instruction.

If the external exception is a directed external exception and the logical partition has external exceptions currently disabled, the hypervisor requests a mediated external exception, such as by setting a mediated exception request (MER) bit in a logical partition control register (LPCR), for example, and returns to the logical partition at the instruction which was interrupted by the hypervisor receiving the direct external interrupt. Thus, when the OS in the logical partition enables external exceptions, a mediated external interrupt occurs, because a mediated external exception has been requested. As a result, the state of the logical partition, e.g., the contents of the machine state register (MSR) and the program counter, are stored in the SRRs.

With the above mechanisms, the hypervisor receives all external interrupts generated as a result of external exceptions originated by external devices. Thus, the state of the logical partition's program counter and MSR is stored by the hardware in the HSRRs when an external exception/interrupt is generated. If the external exception/interrupt is for a currently active logical partition (LPAR), and external exception handling is enabled, then the contents of the HSRRs may be copied to the SRRs to thereby emulate the directed external interrupt corresponding to the external exception. The hypervisor may then redirect execution to the LPAR operating system's external interrupt handler which handles the external interrupt and returns to the instruction that was interrupted by the original external interrupt. If external exception handling is not enabled, then a mediated exception request is generated by the hypervisor, as discussed above. If the external exception is directed to a LPAR that is not currently active, then a logical partition context switch is performed prior to determining whether external exception handling is enabled. In the case of a mediated exception request being pending, once external exception handling is enabled, an interrupt corresponding to the mediated external exception occurs and the state of the logical partition is stored in the SRRs.

In one illustrative embodiment, the OS of a logical partition is able to set a bit in the machine state register (MSR) to enable and/or disable directed external exceptions, e.g., the machine state register external exceptions (MSR[EE]) bit. In addition, the hypervisor is able to set a bit in a logical partition control register (LPCR) to cause mediated external exceptions to occur, e.g., a logical partition control register mediated exception request (LPCR[MER]) bit. The setting of the LPCR[MER] bit causes a mediated external interrupt to occur in response to an OS of the logical partition re-enabling external exception handling.

In operation, when an external exception occurs for a logical partition, and the microprocessor is in a state in which the hypervisor receives all external interrupts, e.g., logical partition environment selector bit zero (LPES[0]) is set to 0, the external interrupt corresponding to the external exception is provided to and received in the hypervisor. The microprocessor state of the currently active LPAR is stored, by the microprocessor hardware, in the HSRRs (a hypervisor resource) in response to this external exception in order to avoid corruption of the SRRs. In response to receiving the external interrupt, the hypervisor determines if the external exception is a directed external exception that is directed to a currently active logical partition or another partition.

If the external exception is directed to the currently active logical partition, the hypervisor determines if external exception handling is currently disabled or enabled by the OS of the currently active logical partition. If external exception handling is currently enabled by the currently active logical partition, then the hypervisor copies the state information from the HSRRs into the SRRs and invokes the external exception handler of the OS of the currently active logical partition.

If external exception handling is currently disabled, i.e. MSR[EE]=0, the hypervisor sets a mediated exception request, such as by setting a logical partition control register mediated exception request (LPCR[MER]) bit and returns to the logical partition, such as by performing an IRET, whereby the state of the logical partition is restored from the HSRRs as if the external interrupt never occurred. Thereafter, when the OS of the currently active logical partition re-enables external exception handling, such as when the OS exits a critical section of code, because the mediated exception request is set, a mediated interrupt will immediately occur thereby saving the program counter and MSR state of the logical partition being stored in the SRRs. The hypervisor then redirects execution to the logical partition's external interrupt handler to handle the external exception.

If the external exception is directed to another logical partition, the hypervisor must determine whether to perform a logical partition context switch to that other logical partition or not. Basically, the hypervisor determines if the external exception has a sufficiently high priority to warrant a logical partition context switch. For example, if the external exception is directed to a logical partition running a realtime OS, then the priority of the external exception may be considered to be of a highest priority and a logical partition context switch is warranted. If the external exception is directed to another logical partition, and a logical partition context switch is to be performed, the state information for the current logical partition is stored in the logical partition's context storage area and the state of the other logical partition is restored from its context storage area. Thereafter, the above operation for determining whether external exception handling is enabled, whether to set a mediated exception request, etc. is performed with regard to the now currently active logical partition.

In one illustrative embodiment, a method for handling external exceptions is provided. The method may comprise receiving, from a device external to a microprocessor, an external interrupt corresponding to an external exception and determining if a logical partition to which the external interrupt is directed has external interrupt handling currently enabled. The method may further comprise generating a mediated exception request if the logical partition to which the external interrupt is directed does not have external interrupt handling currently enabled, whereby the mediated exception request is pending. The method may also comprise invoking an external interrupt handler to process the external interrupt in response to an operating system of the logical partition re-enabling external interrupt handling and the mediated exception request being pending. The operating system may, for example, disable external interrupt handling when the operating system executes critical code and re-enables external interrupt handling after execution of the critical code is complete.

The method may further comprise restoring, in response to the generation of the mediated exception request, a state of the logical partition to a state prior to receiving the external interrupt. Control of the microprocessor may be returned to the logical partition in response to restoring the state of the logical partition.

Determining if a logical partition to which the external interrupt is directed has external interrupt handling currently enabled may comprise determining if an external exception bit of a machine state register of the microprocessor is set. Generating a mediated exception request may comprise setting a mediated exception request bit in a logical partition control register of the microprocessor.

The method is implemented by a hypervisor executing in the microprocessor. The method may further comprise storing state information for the logical partition in hypervisor state restore registers associated with the hypervisor. The method may also comprise copying the state information to state restore registers associated with an operating system of the logical partition if the logical partition has external interrupt handling currently enabled.

The method may further comprise determining if the external interrupt is directed to a currently active logical partition, and performing a logical partition context switch operation from the currently active logical partition to the logical partition to which the external interrupt is directed if the external interrupt is not directed to the currently active logical partition. A determination may be made as to whether the logical partition context switch operation should be performed based on a priority associated with the external interrupt. The logical partition context switch operation may be performed only if the priority associated with the external interrupt meets a predetermined criteria.

The microprocessor may be part of a heterogeneous system-on-a-chip that comprises a control processor and one or more co-processors. The control processor may operate using a first instruction set that is different from a second instruction set used by the one or more co-processors. Moreover, the external interrupt may originate with an external exception in one of the one or more co-processors.

In other illustrative embodiments, a computer program product comprising a computer useable medium having a computer readable program is provided. The computer readable program, when executed on a computing device, causes the computing device to perform various ones, and combinations of, the operations outlined above with regard to the method illustrative embodiment.

In yet another illustrative embodiment, an apparatus is provided. The apparatus may comprise a processor and a memory coupled to the processor. The memory may comprise instructions which, when executed by the processor, cause the processor to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary block diagram of a data processing system in which exemplary aspects of the illustrative embodiments may be implemented;

FIG. 2 is an exemplary block diagram illustrating the primary operational components of the illustrative embodiments;

FIG. 3A is an exemplary diagram of a machine state register in accordance with one illustrative embodiment;

FIG. 3B is an exemplary diagram of a logical partition control register in accordance with one illustrative embodiment; and

FIG. 4 is a flowchart outlining an exemplary operation of the illustrative embodiments.

### DETAILED DESCRIPTION OF THE ILLUSTRATIVE EMBODIMENTS

The illustrative embodiments provide a mechanism for mediated external exceptions such that external exceptions may be processed by a hypervisor even when external exceptions are disabled by an OS of a logical partition. The mechanisms of the illustrative embodiments may be implemented in any data processing system in which logical partitioning is utilized and external exceptions may be disabled by an operating system. In particular, the mechanisms of the illustrative embodiments may be implemented with shared processors, i.e. processors that run a plurality of logical partitions each having their own operating system instance.

In some illustrative embodiments, the shared processor is a PowerPC® microprocessor. In other illustrative embodiments, the mechanisms are utilized with the Cell Broadband Engine available from International Business Machines, Inc. of Armonk, N.Y. For purposes of the present description, it will be assumed that the data processing system in which the illustrative embodiments are implemented is a Cell Broadband Engine heterogeneous system-on-a-chip, however this is not intended to state or imply any limitation with regard to the data processing systems in which the illustrative embodiments may be implemented.

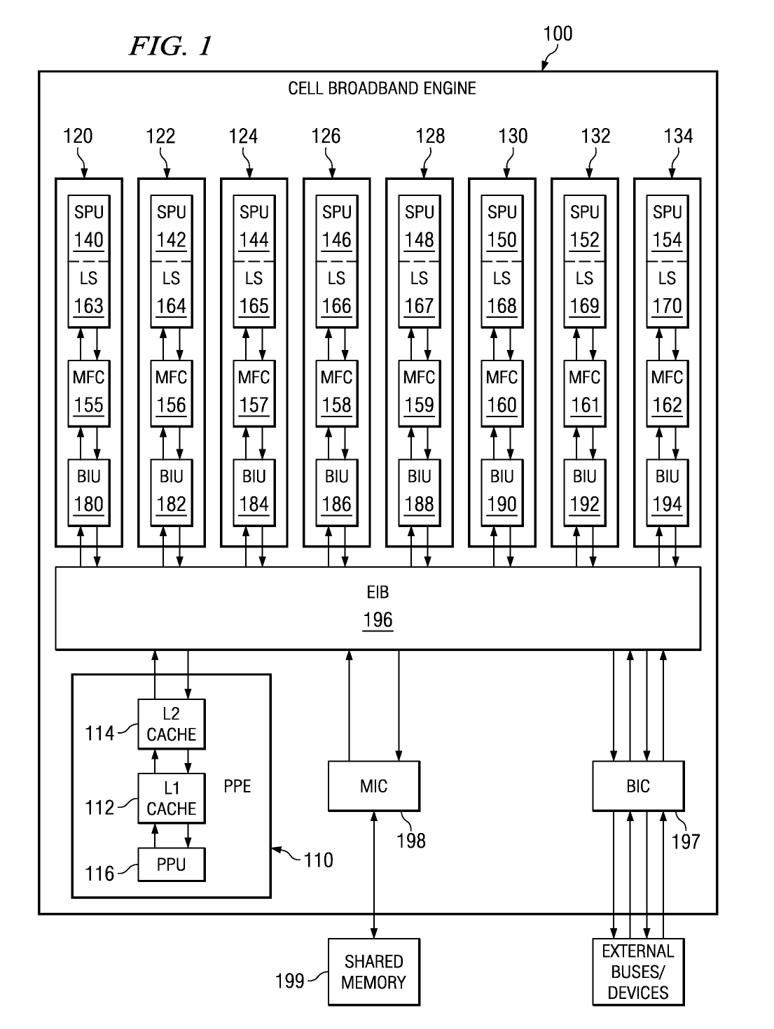

FIG. 1 is an exemplary block diagram of a data processing system in which aspects of the present invention may be implemented. The exemplary data processing system shown in FIG. 1 is an example of the Cell Broadband Engine (CBE) data processing system. While the CBE will be used in the description of the preferred embodiments of the present invention, the present invention is not limited to such, as will be readily apparent to those of ordinary skill in the art upon reading the following description.

As shown in FIG. 1, the CBE 100 includes a power processor element (PPE) 110 having a processor (PPU) 116 and its L1 and L2 caches 112 and 114, and multiple synergistic processor elements (SPEs) 120-134 that each has its own synergistic processor unit (SPU) 140-154, memory flow control 155-162, local memory or store (LS) 163-170, and bus interface unit (BIU unit) 180-194 which may be, for example, a combination direct memory access (DMA), memory management unit (MMU), and bus interface unit. The PPU 116 may be a PowerPC® microprocessor, for example. A high bandwidth internal element interconnect bus (EIB) 196, a bus interface controller (BIC) 197, and a memory interface controller (MIC) 198 are also provided.

The local memory or local store (LS) 163-170 is a non-coherent addressable portion of a large memory map which, physically, may be provided as small memories coupled to the SPUs 140-154. The local stores 163-170 may be mapped to different address spaces. These address regions are continuous in a non-aliased configuration. A local store 163-170 is associated with its corresponding SPU 140-154 and SPE 120-134 by its address location, such as via the SPU Identification Register, described in greater detail hereafter. Any resource in the system has the ability to read/write from/to the local store 163-170 as long as the local store is not placed in a secure mode of operation, in which case only its associated SPU may access the local store 163-170 or a designated secured portion of the local store 163-170.

The CBE 100 may be a system-on-a-chip such that each of the elements depicted in FIG. 1 may be provided on a single microprocessor chip. Moreover, the CBE 100 is a heterogeneous processing environment in which each of the SPUs may receive different instructions from each of the other SPUs in the system. Moreover, the instruction set for the SPUs is different from that of the PPU, e.g., the PPU may execute Reduced Instruction Set Computer (RISC) based instructions while the SPU execute vectorized instructions.

The SPEs 120-134 are coupled to each other and to the L2 cache 114 via the EIB 196. In addition, the SPEs 120-134 are coupled to MIC 198 and BIC 197 via the EIB 196. The MIC 198 provides a communication interface to shared memory 199. The BIC 197 provides a communication interface between the CBE 100 and other external buses and devices.

The PPE 110 is a dual threaded PPE 110. The combination of this dual threaded PPE 110 and the eight SPEs 120-134 makes the CBE 100 capable of handling 10 simultaneous threads and over 128 outstanding memory requests. The PPE 110 acts as a controller for the other eight SPEs 120-134 which handle most of the computational workload. The PPE 110 may be used to run conventional operating systems while the SPEs 120-134 perform vectorized floating point code execution, for example.

The SPEs 120-134 comprise a synergistic processing unit (SPU) 140-154, memory flow control units 155-162, local memory or store 163-170, and an interface unit 180-194. The local memory or store 163-170, in one exemplary embodiment, comprises a 256 KB instruction and data memory which is visible to the PPE 110 and can be addressed directly by software.

The PPE 110 may load the SPEs 120-134 with small programs or threads, chaining the SPEs together to handle each step in a complex operation. For example, a set-top box incorporating the CBE 100 may load programs for reading a DVD, video and audio decoding, and display, and the data would be passed off from SPE to SPE until it finally ended up on the output display. At 4 GHz, each SPE 120-134 gives a theoretical 32 GFLOPS of performance with the PPE 110 having a similar level of performance.

The memory flow control units (MFCs) 155-162 serve as an interface for an SPU to the rest of the system and other elements. The MFCs 155-162 provide the primary mechanism for data transfer, protection, and synchronization between main storage and the local storages 163-170. There is logically an MFC for each SPU in a processor. Some implementations can share resources of a single MFC between multiple SPUs. In such a case, all the facilities and commands defined for the MFC must appear independent to software for each SPU. The effects of sharing an MFC are limited to implementation-dependent facilities and commands.

With the CBE architecture of FIG. 1, the PPE 110 may have an associated hypervisor or other logical partitioning control mechanism that facilitates logical partitioning of the resources of the CBE 100. The hypervisor may support multiple logical partitions on the CBE 100. Each logical partition may be associated with one or more SPEs 120-134, external input/output (I/O) devices, and other CBE 100 resources, and may run a separate operating system instance. The external I/O devices and SPEs 120-134 may generate external exceptions which in turn generate external interrupts that are sent to the PPE 110 for processing. Such external exceptions may occur, for example, when the SPEs 120-134 or external I/O devices require services from the PPE 110 in order to perform their operations. With regard to the SPEs 120-134, such external exceptions may occur in response to execution of code in the SPEs 120-134 that results in an external interrupt being generated.

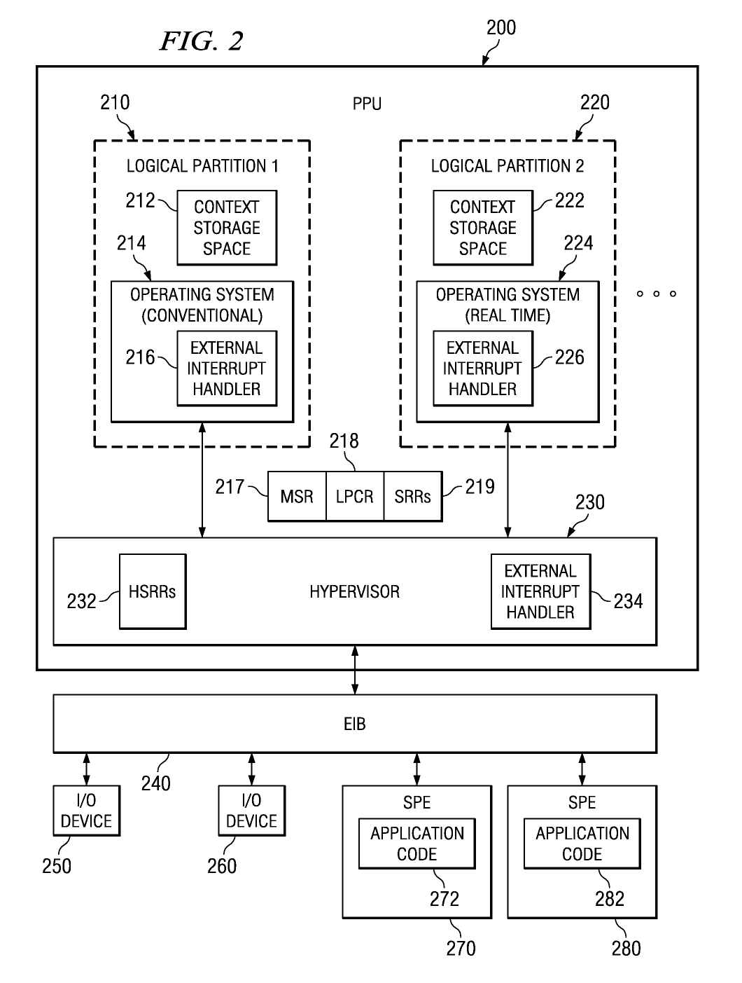

In these illustrative embodiments, it is assumed that the CBE 100 is set to a state in which all external interrupts from the SPEs 120-134, external I/O devices, or the like, are sent to the hypervisor rather than to an operating system (OS) of a logical partition. The hypervisor is provided with mechanisms for determining when to perform logical partition context switches, when to execute external exception handling in a logical partition, and when to set mediated external exception requests with regard to logical partitions. These mechanisms will be described with regard to the primary operational components of the illustrative embodiments as illustrated in FIG. 2.

FIG. 2 is an exemplary block diagram illustrating the primary operational components of the illustrative embodiments. As shown in FIG. 2, a power processing unit (PPU) 200 runs two or more logical partitions 210 and 220 with which various data processing system resources, operating systems, and the like are associated, as is generally known in the art. It should be appreciated that various ones of the I/O devices 250-260 and SPEs 270 and 280 may be associated with each of these logical partitions 210 and 220 although for purposes of ease of illustration, these associations are not depicted in FIG. 2.

In a first logical partition 210, a first operating system (OS) 214 is run which has an associated external interrupt handler 216. The operating system 214, for purposes of this exemplary illustration, is assumed to run a conventional OS, i.e. a non-real time OS. This conventional OS may be used, in conjunction with one or more corresponding SPEs 270 and 280, to execute code that does not perform time sensitive tasks, for example. The first logical partition 210 further includes a context storage space 212 into which state information may be stored in the event of a logical partition context switch on the PPU 200 from the first logical partition 210 to the second logical partition 220.

The second logical partition 220 has similar components associated with it, i.e. an OS 224 having an associated external interrupt handler 226, and a context storage space 222. In the second logical partition 220, however, it is assumed, for purpose of this exemplary illustration, that the OS 224 is a real time OS. It should be appreciated that the mechanisms of the illustrative embodiments do not require that a real time OS be provided in one of the logical partitions. Rather, the real time OS is used as exemplary of an environment that would be associated with high priority external interrupts that would utilize the mechanisms of the illustrative embodiments as described hereafter. It should be appreciated that other types of OS may be utilized, such as a both logical partitions running conventional OS, without departing from the spirit and scope of the illustrative embodiments.

The PPU 200 further has an associated machine state register (MSR) 217, a logical partition control register (LPCR) 218, and state restore registers (SRRs) 219. The MSR 217 stores state information for the PPU 200 including information regarding whether or not external exceptions (or interrupts) are enabled, whether or not to invoke the hypervisor 230 in response to external interrupts, a problem state of the PPU 200, and the like. The LPCR 218 stores control information for controlling the operation of the various logical partitions 210-220 running on the PPU 200 including information regarding whether the PPU 200 is in a state in which all external interrupts are sent to the hypervisor and whether a mediated external exception request is pending. The SRRs 219 store state information for a logical partition 210-220 in the event of an external interrupt so that the state of the logical partition 210-220 may be restored after handling of the external interrupt by an external interrupt handler 216 or 226. More information regarding the MSR 217, LPCR 218, and SRRs 219 may be found in the PowerPC Operating Environment Architecture Book III, version 2.01, December 2003, available from International Business Machines, Inc. at www-128.ibm.com/developerworks/eserver/articles/archguide.html.

In addition to the above, the PPU 200 has an associated hypervisor 230 which is used to control and manage the operation of the logical partitions 210-220. The hypervisor 230 has associated hypervisor state restore registers (HSRRs) 232 for storing state information of a currently active logical partition in the event of an external exception occurring, as will be described in greater detail hereafter. External I/O devices 250-260 and SPEs 270-280 may communicate with the PPU 200, and thus, the hypervisor 230 and logical partitions 210-220, via a bus 240, which in the depicted example is a high bandwidth internal element interconnect bus (EIB) 240.

With these primary operational components in mind, external interrupts may be generated in response to external exceptions occurring in one or more of the external I/O devices 250-260 or SPEs 270-280. For example, a SPE 270 may execute application code 272 within the second logical partition 220 and, as a consequence of executing the application code 272, may generate an external exception requiring attention by the PPU 200. As a result, the SPE 270 may send an external interrupt to the PPU 200 requesting that the PPU 200 provide services for handling the external interrupt and providing the SPE 270 with what it needs to continue operation.

With regard to the mechanisms of the illustrative embodiments, it is assumed that the PPU 200 has been placed into a state for sending all external interrupts to the hypervisor by setting a bit in the LPCR 218 to indicate that all external interrupts are to be provided to the hypervisor 230 rather than to the OS of the particular logical partition 210-220. Thus, when the SPE 270 sends the external interrupt to the PPU 200 via the EIB 240, the external interrupt is provided to the hypervisor 230.

In response to receiving the external interrupt, for example, the hypervisor 230 may determine a priority of the external interrupt and whether or not the external interrupt is directed to a currently active logical partition 210, i.e. the logical partition in which instructions are currently executing, or another logical partition, e.g., logical partition 220, that is currently not active. If the external interrupt is directed to the currently active logical partition 210, then a logical partition context switch is not necessary. However, if the external interrupt is directed to another logical partition, e.g., logical partition 220, it may be necessary to perform a logical partition context switch if the priority of the external interrupt is of a sufficiently high priority, i.e. if the priority meets a predetermined criteria for performing a logical partition context switch. For example, external interrupts that occur in the second logical partition 220 running a real time operating system (OS) 224 may be considered to be of a high priority requiring a logical partition context switch from a currently active logical partition 210 which is running, for example, the conventional OS 214.

If a logical partition context switch is necessary, the hypervisor 230 stores the current state information for the OS 214 of the active, or “current,” logical partition 210 in the context storage space 212 associated with that logical partition 210 and the hypervisor 230 redirects execution to the other logical partition 220 to which the external interrupt is directed. This state information may include, for example, the state of the MSR 217, the LPCR 218, a program counter for the logical partition 210, and the like. As part of the MSR 217 state information, the state of an external exception enable/disable bit in MSR 217 is stored which indicates whether external exceptions were enabled or disabled at the time of the logical partition context switch. As part of the LPCR 218 state information, the state of a mediated exception request (MER) bit in the LPCR 218 may be stored which indicates whether a mediated exception request was pending at the time of the logical partition context switch.

When redirecting execution to the other logical partition, e.g., the second logical partition 220, the state information stored in the context storage space 222 for this other logical partition 220 is restored. Thus, the state information in the context storage space 222 is copied into the MSR 217, LPCR 218, and the program counter for the second logical partition 220 to thereby restore the state of the logical partition to a state at which a previous logical partition context switch occurred from the second logical partition 220 to the first logical partition 210. This state information obtained from the context storage space 222 includes the previous state of the external exception enable/disable bit in the MSR 217 and the state of the mediated exception request bit in the LPCR 218. Thus, the second logical partition 220 may or may not have had external exceptions enabled prior to a previous logical partition context switch, may or may not have had a pending mediated exception request, and these states are restored upon a context switch back to the second logical partition 220.

If the logical partition to which the external exception was directed is the currently active logical partition 210, a logical partition context switch is not necessary. Thus, the hypervisor 230 determines, based on the LPCR 218, if the external exception is a directed external exception (not a mediated external exception). The hypervisor 230 further determines, based on the MSR 217, if the currently active logical partition 210 has external exception handling enabled.

If the external exception is a directed external exception and the logical partition 210 has external exceptions enabled in the MSR 217, the hypervisor 230 sets the appropriate registers to emulate the external interrupt corresponding to the external exception and returns to the external interrupt handler 216 of the logical partition's OS 214. In setting the registers to emulate the external interrupt, state information that is stored by the microprocessor hardware in response to the external exception in the HSRRs 232, e.g., the state of the MSR 217, LPCR 218, and a program counter, is copied to the SRRs 219 for use in restoring the state of the logical partition 210 after an Interrupt Return (IRET) from the external interrupt handler 216.

Thereafter, the hypervisor restores the mediated exception request (MER) bit value in the LPCR 218 for the logical partition 210. The restoring of this MER bit is performed in order to address the situation where a directed external exception occurs and is directed to the logical partition 210 at the same time that there is an outstanding mediated exception request, as discussed hereafter, associated with the logical partition 210. Such a situation may arise, for example, where the OS 214 is in an external interrupt handler 216 and another external exception is received by the hypervisor 230 which in turn sets the mediated exception request while the OS 214 is currently handling a directed external interrupt already. In such a situation, it is important to restore the MER bit so that the mediated exception request may be properly processed.

If the logical partition 210 does not have external exception handling enabled in the MSR 217, then the hypervisor 230 sets a mediated exception request (MER) bit in the LPCR 218 and returns control to the OS 214 of the logical partition 210 using the state information stored in the HSRRs 232. That is, the state information in the HSRRs 232 is used to restore the logical partition 210 to a state as if the external interrupt did not occur. In this way, the logical partition 210 may continue to process the critical portion of code that is the reason for the external exception handling being disabled.

Once the OS 214 of the logical partition 210 restores external exception handling, e.g., after execution of the critical portion of code has completed, because the MER bit is set in the LPCR 218 and the original external interrupt was not handled, a mediated external interrupt occurs. The mediated external interrupt occurs due to the hardware checking the state of the MER bit of the LPCR in response to external exception handling bit being set or restored. When the MER bit is set and external exception handling is re-enabled, the hardware triggers the mediated external interrupt which invokes the hypervisor external interrupt handler. Thus, the mediated external interrupt is seen by the external interrupt handler 234 of the hypervisor. With this mediated external interrupt, since external exception handling has now been enabled by the OS 214 of the logical partition 210, the state information has been stored in the SRRs 219 and the external interrupt handler 216 of the logical partition 210 may be invoked to handle the device or unit exception.

If the original external exception is directed to a different logical partition than the currently active logical partition, e.g., logical partition 220 rather than logical partition 210, then a logical partition context switch may be performed. Based on the priority of the external exception, the external interrupt handler 234 of the hypervisor 230 may determine whether to perform the logical partition context switch. For example, in the depicted example assume that the external exception occurred in an external I/O device or SPE associated with the second logical partition 220 and thus, the external exception is directed to the second logical partition 220. As a result, a logical partition context switch has been performed by the hypervisor 230 from the first logical partition 210 to the second logical partition 220 since the external exception is considered to be of high priority, e.g., directed to a logical partition running a real time OS. In other illustrative embodiments, a relative priority between the currently active logical partition and the logical partition to which the external exception is directed. As part of the context switch, the state of the first logical partition 210 is stored in its context storage space 212 and the state information for the second logical partition is restored from its context storage space 222.

The hypervisor 230, following the logical partition context switch, then performs the operations outlined above with regard to determining whether external exception handling is enabled by the now currently active logical partition 220 and setting of a mediated exception request if necessary. If the now currently active logical partition 220 has external exception handling enabled, then the external interrupt corresponding to the external exception that is directed to the second logical partition 220 may be immediately directed to the external interrupt handler 226 of the OS 224 in the second logical partition 220. As a result, the state information for the logical partition 220 may be stored in the SRRs 229 and utilized to restore the state after handling of the external interrupt by the external interrupt handler 226. If the now currently active logical partition 220 has external exceptions disabled, then the hypervisor 230 sets a mediated exception request bit in the LPCR 218 as described above and awaits the re-enabling of external exception handling by the OS 224 of the logical partition 220 as described above.

When processing a mediated external interrupt, either in the logical partition 210 when the external exception is directed to that logical partition 210 or after a context switch when the external exception is directed to logical partition 220, the hypervisor 230 may determine if all mediated exception requests have been presented to the logical partition 210 or 220 for handling. The hypervisor 230 may set the MER bit of the LPCR 218 to indicate that there are no pending mediated exception requests if all mediated exception requests have been handled by the logical partition. Otherwise, the hypervisor 230 restores the MER bit in the LPCR 218, as discussed previously.

As described above, the mechanisms of the illustrative embodiments make use of the machine state register (MSR), the logical partition control register (LPCR), state save/restore registers (SRRs), and hypervisor state save/restore registers (HSRRs). These elements are all present in existing PowerPC® microprocessors, but are not utilized in the manner set forth by the illustrative embodiments herein. In particular, the mechanisms of the illustrative embodiments utilize the setting of various bits in these registers to control the operation of the logical partitions and the hypervisor when receiving an external interrupt. Moreover, the setting of these various bits is utilized by the illustrative embodiments to mediate external interrupt handling by the external interrupt handlers of the various logical partitions.

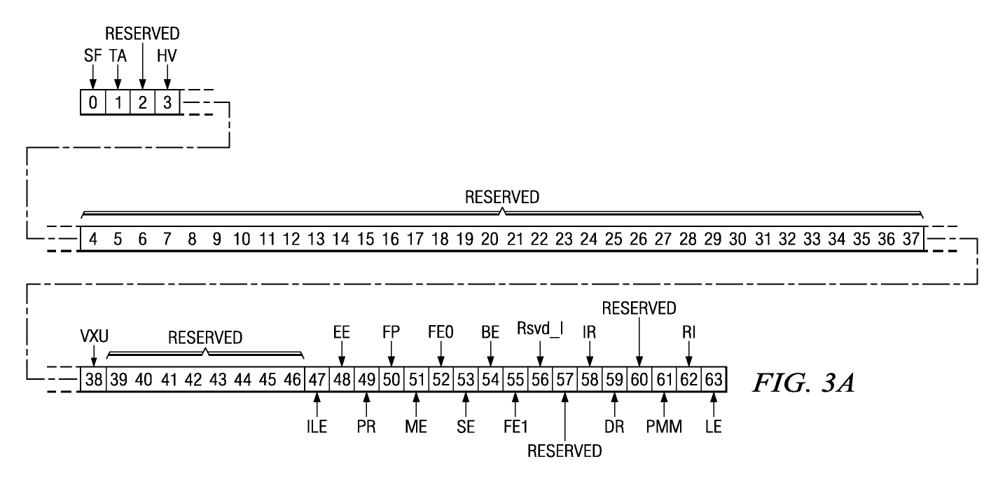

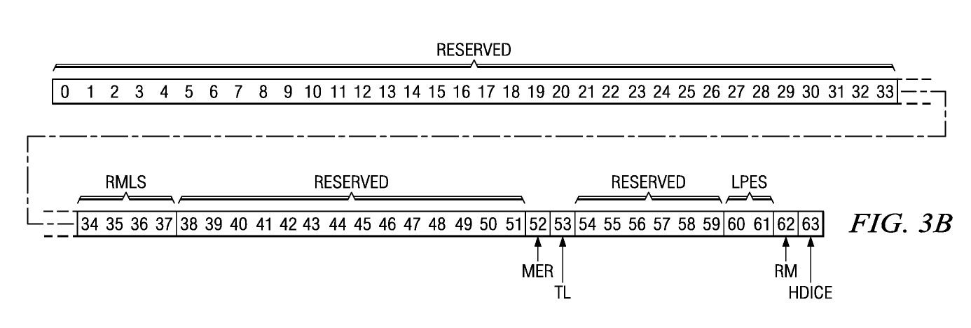

FIG. 3A is an exemplary diagram of a machine state register (MSR) in accordance with one illustrative embodiment. With regard to the mechanisms of the illustrative embodiments, the bits of the MSR 300 that are utilized are MSR[HV] (bit 3) and MSR[EE] (bit 48). The MSR[HV] bit causes the hypervisor to be invoked in response to an external interrupt. This bit is utilized to ensure that all external interrupts are directed to the hypervisor rather than individual operating systems of logical partitions for handling. With regard to the illustrative embodiments, the setting of this bit enables the hypervisor to mediate external interrupts.

The MSR[EE] bit identifies whether or not external exceptions are enabled or disabled for a currently active logical partition. The setting of this MSR[EE] bit by an OS of a logical partition controls whether the hypervisor invokes the external interrupt handler of the logical partition's OS to handle a received external interrupt and whether to set a mediated exception request.

FIG. 3B is an exemplary diagram of a logical partition control register (LPCR) in accordance with one illustrative embodiment. With regard to the mechanisms of the illustrative embodiments, the bits of the LPCR 350 that are utilized are the logical partition control register logical partition environment selector (LPCR[LPES[0]]) bit (bit 60) and the logical partition control register mediated exception request (LPCR[MER]) bit (bit 52). The LPCR[LPES[0]] bit identifies when the processor is in a state where all external interrupts are to be provided to the hypervisor. The LPCR[MER] bit, which may be set by the hypervisor, identifies when a mediated exception request is pending for a currently active logical partition.

With these bits of the MSR 300 and LPCR 350, directed external interrupts are enabled if the following expression is “1”:

MSR[EE]|̂(LPES[0]|MSR[HV])

In other words, directed external interrupts are enabled when external exceptions are enabled or when external exceptions are directed to the hypervisor and the processor is not currently in hypervisor state. Mediated external interrupts are enabled if the value of the following expression is “1”:

MSR[EE] & (̂(MSR[HV])|MSR[PR])

In other words, Mediated external interrupts are enabled when external exceptions are enabled and the processor is not executing in the hypervisor. In particular, mediated external interrupts are always disabled if the processor is executing in the hypervisor (microprocessor is in the hypervisor state).

Thus, the illustrative embodiments provide a mechanism for providing mediated external exceptions in a logically partitioned data processing environment. The illustrative embodiments permit a mediated exception request to be set when external interrupt handling is disabled for a logical partition to which the external interrupt is to be directed. This mediated exception request allows control to be returned to the logical partition so that critical code portions may be processed. When the logical partition completes execution of the critical code portion, a mediated external interrupt may be generated as a result of the setting of the mediated exception request so as to allow the original external interrupt to be processed as soon as the operating system of the logical partition re-enables external exception handling. As a result, external interrupts may still be received in the hypervisor even when external interrupt handling is disabled by the operating system of the logical partition to which the external interrupt is directed.

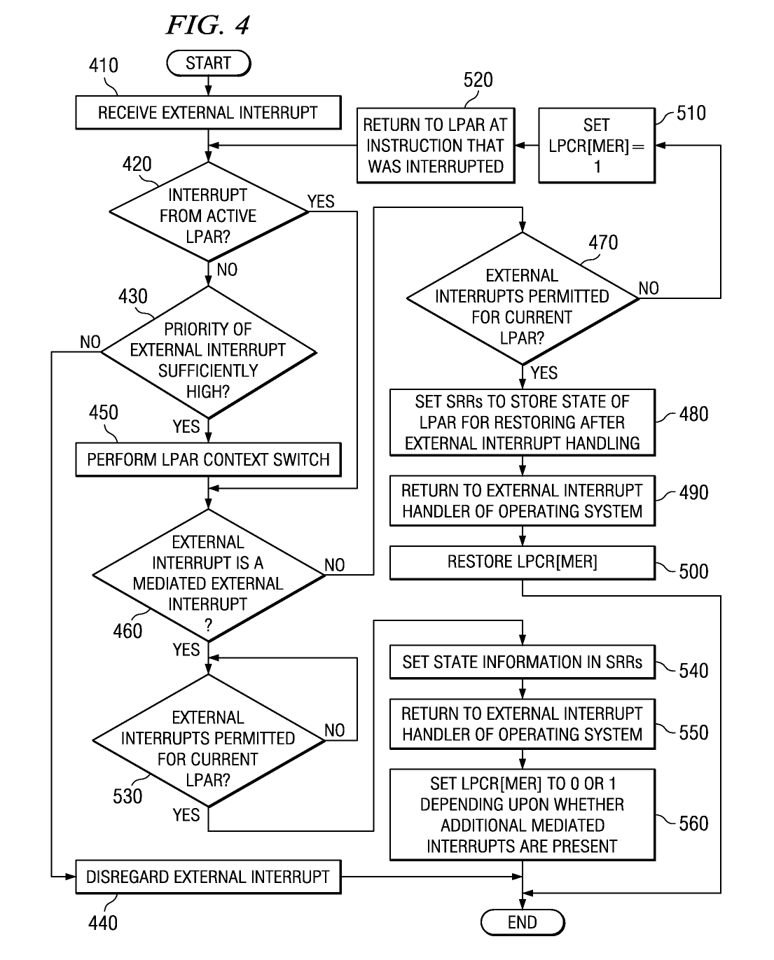

FIG. 4 is a flowchart outlining an exemplary operation of the illustrative embodiments. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 4, the operation starts with the hypervisor receiving an external interrupt (step 410). It is assumed for purposes of this description that the data processing system is set to a state in which all external interrupts are directed to the hypervisor rather than the operating system of the logical partition. The hypervisor determines whether the external interrupt is directed to a currently active logical partition (LPAR) or another LPAR (step 420). If the external interrupt is directed to another LPAR, then a LPAR context switch operation may be necessary. The hypervisor determines whether a LPAR context switch is necessary by determining if the priority of the external interrupt is sufficiently high enough to warrant a LPAR context switch (step 430). There may be many different ways to structure such a determination based on priorities and thus, this step may be implementation specific.

If the external interrupt does not have a sufficiently high priority, then the external interrupt is disregarded (step 440). If the priority of the external interrupt is sufficiently high (step 430), the hypervisor performs a LPAR context switch operation (step 450). This LPAR context switch operation may involve, for example, storing the current state of the currently active LPAR in its context storage space and restoring the state of the LPAR to which execution is being redirected from the context storage space of this now currently active LPAR.

Thereafter, or if the external interrupt is directed to the currently active LPAR (step 420), the hypervisor determines if the external interrupt is a mediated external interrupt, i.e. determines if LPCR[MER]=1 (step 460). If the external interrupt is not a mediated external interrupt, i.e. the external interrupt is a directed external interrupt and LPCR[MER]=0, the hypervisor determines whether external interrupts are permitted for the current LPAR (step 470). If external interrupts are permitted for the current LPAR, i.e. MSR[EE]=1, the hypervisor stores the state information for the LPAR in the SRRs (step 480). This may involve, for example, copying state information from HSRRs associated with the hypervisor to the SRRs. The hypervisor then returns control to the external interrupt handler of the OS for the current LPAR (step 490). When the external interrupt handler returns to the hypervisor, the hypervisor restores the mediated external exception request bit value in the logical partition control register (step 500) and the operation terminates.

If the current LPAR does not permit external interrupts (step 470), i.e. MSR[EE]=0, then the hypervisor sets a mediated exception request, i.e. sets LPCR[MER]=1 (step 510). The hypervisor then returns control to the LPAR at the instruction that was interrupted (step 520). For example, the hypervisor may restore the state of the LPAR to a state prior to the external interrupt, based on state information stored in the HSRRs, and then pass control back to the OS of the logical partition. The operation then returns to step 420.

If the external interrupt is a mediated external interrupt, i.e. LPCR[MER]=1 (step 460), the hypervisor then determines if external interrupts are permitted for the current LPAR (step 530). If external interrupts are not permitted, i.e. MSR[EE]=0, then the hypervisor waits for external interrupts to be re-enabled, i.e. the operation loops back to step 530. If external interrupts are permitted, i.e. MSR[EE]=1, the hypervisor sets the SRRs to emulate the original directed external interrupt (step 540). This may be done, for example, by copying data from the HSRRs to the SRRs. Thereafter, control is returned to the external interrupt handler of the OS in the currently active LPAR (step 550). When the external interrupt handler returns control to the hypervisor after handling the external interrupt, the hypervisor sets mediated external interrupt enable bit, i.e. LPCR[MER] to either 0 or 1 depending upon whether additional mediated interrupts are present or not (step 560). The operation then terminates.

Thus, with the illustrative embodiments, the hypervisor, or other logical partition control mechanism, is given the ability to determine whether an external exception is of a priority that warrants a LPAR context switch to handle the external exception. The hypervisor further determines when the external exception should be handled as a mediated external exception based on whether or not external exception handling is enabled by the logical partition to which the external exception is directed. In this way, external interrupts of external exceptions may be accepted by the hypervisor even when an operating system of a LPAR has disabled external exception handling, such as when critical code sections are being executed by the operating system. The hypervisor accepts such interrupts without compromising the integrity of the LPARs running on the microprocessor by utilizing HSRRs to store state information.

It should be noted that while the illustrative embodiments described above are directed to a system in which a logical partition control mechanism handles external interrupts and determines whether to set a mediated exception request or not based on the current state of the logical partition to which the external interrupt is directed, the present invention is not limited to such. Rather, the mechanisms of the illustrative embodiments may be performed in data processing environments where external interrupts are not directly sent to the hypervisor or other logical partition control mechanism. In fact, the mechanisms of the illustrative embodiments may be utilized in any data processing environment in which an element that receives external interrupts may implement the mechanisms for determining if a logical partition to which the external interrupt is directed has external interrupt handling currently enabled, generating a mediated exception request if the logical partition to which the external interrupt is directed does not have external interrupt handling currently enabled, whereby the mediated exception request is pending, and invoking an external interrupt handler to process the external interrupt in response to an operating system of the logical partition re-enabling external interrupt handling and the mediated exception request being pending.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a microprocessor, for handling external exceptions, comprising:
receiving, from a device external to the microprocessor, an external interrupt corresponding to an external exception;
determining if a logical partition to which the external interrupt is directed has external interrupt handling currently enabled;
generating a mediated exception request if the logical partition to which the external interrupt is directed does not have external interrupt handling currently enabled, whereby the mediated exception request is pending; and
invoking an external interrupt handler to process the external interrupt in response to an operating system of the logical partition re-enabling external interrupt handling and the mediated exception request being pending.

2. The method of claim 1, further comprising:
restoring, in response to the generation of the mediated exception request, a state of the logical partition to a state prior to receiving the external interrupt; and
returning control of the microprocessor to the logical partition in response to restoring the state of the logical partition.

3. The method of claim 1, wherein determining if a logical partition to which the external interrupt is directed has external interrupt handling currently enabled comprises determining if an external exception bit of a machine state register of the microprocessor is set.

4. The method of claim 1, wherein generating a mediated exception request comprises setting a mediated exception request bit in a logical partition control register of the microprocessor.

5. The method of claim 1, wherein the method is implemented by a hypervisor executing in the microprocessor.

6. The method of claim 5, further comprising:
storing state information for the logical partition in hypervisor state restore registers associated with the hypervisor; and
copying the state information to state restore registers associated with an operating system of the logical partition if the logical partition has external interrupt handling currently enabled.

7. The method of claim 1, further comprising:
determining if the external interrupt is directed to a currently active logical partition; and
performing a logical partition context switch operation from the currently active logical partition to the logical partition to which the external interrupt is directed if the external interrupt is not directed to the currently active logical partition.

8. The method of claim 7, further comprising:
determining if the logical partition context switch operation should be performed based on a priority associated with the external interrupt; and
performing the logical partition context switch operation only if the priority associated with the external interrupt meets a predetermined criteria.

9. The method of claim 1, wherein the operating system disables external interrupt handling when the operating system executes critical code and re-enables external interrupt handling after execution of the critical code is complete.

10. The method of claim 1, wherein the microprocessor is part of a heterogeneous system-on-a-chip that comprises a control processor and one or more co-processors, and wherein the control processor operates using a first instruction set that is different from a second instruction set used by the one or more co-processors.

11. A computer program product comprising a computer useable medium having a computer readable program, wherein the computer readable program, when executed on a microprocessor, causes the microprocessor to:
receive, from a device external to the microprocessor, an external interrupt corresponding to an external exception;
determine if a logical partition to which the external interrupt is directed has external interrupt handling currently enabled;
generate a mediated exception request if the logical partition to which the external interrupt is directed does not have external interrupt handling currently enabled, whereby the mediated exception request is pending; and
invoke an external interrupt handler to process the external interrupt in response to an operating system of the logical partition re-enabling external interrupt handling and the mediated exception request being pending.

12. The computer program product of claim 11, wherein the computer readable program further causes the microprocessor to:
restore, in response to the generation of the mediated exception request, a state of the logical partition to a state prior to receiving the external interrupt; and
return control of the microprocessor to the logical partition in response to restoring the state of the logical partition.

13. The computer program product of claim 11, wherein the computer readable program causes the microprocessor to determine if a logical partition to which the external interrupt is directed has external interrupt handling currently enabled by determining if an external exception bit of a machine state register of the microprocessor is set.

14. The computer program product of claim 11, wherein the computer readable program causes the microprocessor to generate a mediated exception request by setting a mediated exception request bit in a logical partition control register of the microprocessor.

15. The computer program product of claim 11, wherein the computer readable program is implemented by a hypervisor executing in the microprocessor.

16. The computer program product of claim 15, wherein the computer readable program further causes the microprocessor to:
store state information for the logical partition in hypervisor state restore registers associated with the hypervisor; and
copy the state information to state restore registers associated with an operating system of the logical partition if the logical partition has external interrupt handling currently enabled.

17. The computer program product of claim 11, wherein the computer readable program further causes the microprocessor to:
determine if the external interrupt is directed to a currently active logical partition; and
perform a logical partition context switch operation from the currently active logical partition to the logical partition to which the external interrupt is directed if the external interrupt is not directed to the currently active logical partition.

18. The computer program product of claim 17, wherein the computer readable program further causes the microprocessor to:
determine if the logical partition context switch operation should be performed based on a priority associated with the external interrupt; and
perform the logical partition context switch operation only if the priority associated with the external interrupt meets a predetermined criteria.

19. The computer program product of claim 11, wherein the operating system disables external interrupt handling when the operating system executes critical code and re-enables external interrupt handling after execution of the critical code is complete.

20. An apparatus, comprising:
a processor; and
a memory coupled to the processor, wherein the memory contains instructions which, when executed by the processor, cause the processor to:
receive, from a device external to the processor, an external interrupt corresponding to an external exception;
determine if a logical partition to which the external interrupt is directed has external interrupt handling currently enabled;
generate a mediated exception request if the logical partition to which the external interrupt is directed does not have external interrupt handling currently enabled, whereby the mediated exception request is pending; and
invoke an external interrupt handler to process the external interrupt in response to an operating system of the logical partition re-enabling external interrupt handling and the mediated exception request being pending.
